(19) United States
(12) Patent Application Publication
(10) Pub. No.: US 2019/0193511 A1
(43) Pub. Date: Jun. 27, 2019

(54) HEATING SYSTEM WITH HEAT ACCUMULATOR ARRANGEMENT FOR HYBRID OR ELECTRIC VEHICLES, AND METHOD THERETO

(71) Applicant: KONVEKTA AKTIENGESELLSCHAFT (AG), SCHWALMSTADT (DE)

(72) Inventors: MICHAEL SONNEKALB,, Schwalmstadt (DE); Pascal Best, Ottrau (DE)

(21) Appl. No.: 16/183,105

(22) Filed: Nov. 7, 2018

(30) Foreign Application Priority Data
Nov. 14, 2017 (DE) 102017126775.1

(51) Int. Cl. B60H 1/00; B60H 1/22

(52) U.S. Cl. CPC B60H 1/00492; B60H 1/2218; B60H 1/00385; B60H 1/2221

(57) ABSTRACT

The invent inn relates to a heating system (10) for a hybrid or electric vehicle (50) comprising at least one electric machine (12) operable in the generator mode, at least one heat accumulator arrangement (32), al least one electric heating device (30) associated with the heat accumulator arrangement (32), and a switching arrangement (26), wherein the switching arrangement (26) is designed to optionally couple the at least one electric machine (12) with the at least one electric heating device (30) and or an electric energy accumulator (28), when the at least one electric machine (12) operates in the generator mode during a braking process, wherein al least one heat accumulator arrangement (32) has a latent heat accumulator agent (34) for heal storage, comprising at least one sugar alcohol which comprises at least one compound selected from the group consisting of erythritol, threitol, xylitol, mannitol, and dulcitol. With such a heating system (10), heat for heating can be stored well. The invention also relates to a method for accumulating heat and healing with such a heating system (10).

### FIELD OF TECHNOLOGY

The invention relates to a heating system for a hybrid or electric vehicle according to the preamble of claim 1. The heating system is designed such that it utilizes electric energy obtained during the braking process of the hybrid or electric vehicle by means of an electric machine operable in the generator mode and converted into heal, for example, for heating air for the vehicle interior. The invention further relates to a hybrid or electric vehicle with such a heating system, a heal accumulator arrangement for such a heating system, and a method for accumulating heat and releasing accumulated heat by means of such a healing system. In a hybrid vehicle, one of at least two drive types of the vehicle is electric. In an electric vehicle, the drive type is only purely electric.

### PRIOR ART

Heating systems for a hybrid or electric vehicle are known which, through braking, utilize electric energy generated in an electric machine operable in the generator mode. The electric energy thus generated by recuperation is converted into heat for heating, for example, the air for the vehicle interior. So far, the storage capacity of electric energy accumulators has been cost-intensive and elaborate. An electric energy accumulator of the hybrid or electric vehicle only has a limited storage capacity, wherein the energy stored therein is used predominantly for the drive. Heating systems for hybrid or electric vehicles are known, in which the electric energy obtained through braking is storable as converted heat in a heat accumulator arrangement. In DE 10 2012 006 312 A1, a method and a motor vehicle are disclosed, in which the kinetic energy of a hybrid or electric vehicle is converted during braking by recuperation into electric energy and is subsequently converted into heat and stored as heat in a heal accumulator arrangement, wherein its storage medium is an adsorbent that can adsorb other substances while releasing heat, and desorb other substances, when it accumulates heat. For that purpose, a working fluid exists which can be adsorbed/desorbed by the adsorbent. Such a heating system is disadvantageous because it requires a device for collecting the desorbed working fluid as well as both an adsorbent and a working fluid. WO 2017/174803 A1, DE 10 2008 058 712 A1, and DE 10 2009 030 541 A1 each also disclose a healing system for a hybrid or electric vehicle, in which the electric energy obtained during braking and converted into heat can be stored in a heat accumulator arrangement. The heat is stored in a latent heat accumulator arrangement. As a storage medium, a latent heal accumulator arrangement contains latent heat accumulator agents. The latent heat accumulator agent is capable of undergoing a phase transition, whereby the thus gathered heat is stored particularly due to the one phase transition, e.g. from solid to liquid, and subsequently, heat is released with a correspondingly reverse phase transition. Said heat is called latent heat. For example, DE 10 2008 058 712 A1 discloses unspecified salts as latent heat accumulator agents which, in their crystallization state, are susceptible to heat. However, only the crystallization state is influenced. A phase transition effective for storing latent heat is the phase transition from solid to liquid. For that purpose, DE 10 2009 030 541 A1 proposes an unspecified metallic alloy as latent heat accumulator agent. Metallic alloys with high enthalpy of fusion are known, but the melting point at very high temperatures frequently lies significantly above 400 degrees Celsius. This requires an elaborate heat insulation because particularly the risk of burns for vehicle occupants is a problem at such high temperatures. From that point of view, the position of such a heat accumulator arrangement near vehicle occupants is unfeasible. In addition, the utilization of the heat at such high storage temperatures causes problems because at several 100 degrees Celsius, the temperature difference to the temperature of the air to be heated in the vehicle interior provided for the vehicle occupants is very high. Some metallic alloys are also toxic for humans.

The invention thus addresses the first problem of providing an improved heating system for a hybrid or electric vehicle, in which electric energy generated during the braking process and converted into heat can be stored as heat in at least one heat accumulator arrangement in the vehicle.

A second corresponding problem addresses the provision of an improved heat accumulator arrangement for such a heating system. The third problem addresses the provision of a hybrid or electric vehicle with such a heating system. A corresponding fourth problem addresses the provision of an improved method for accumulating heal and releasing stored heat for the heating of air for or in a vehicle interior of a hybrid or electric vehicle provided for vehicle occupants.

### SUMMARY OF THE INVENTION

The first problem is solved by a healing system according to the features of claim 1. The first problem is solved by the heating system for a hybrid or electric vehicle comprising at least one electric machine operable in the generator mode, at least one heal accumulator arrangement, at least one electric heating device associated with the heat accumulator arrangement, and a switching arrangement, wherein the switching arrangement is designed to optionally couple the at least one electric machine with the at least one electric heating device and/or an electric energy accumulator, when the at least one electric machine operates in the generator mode during a braking process, and wherein at least one heat accumulator arrangement has a latent heat accumulator agent for heat accumulation, comprising at least one sugar alcohol which comprises at least one compound selected from the group consisting of erythritol, threitol, xylitol, mannitol, and dulcitol. Such a healing system offers the possibility of convening the energy, which was converted during the braking process from kinetic energy into electric energy, into heat and temporarily store it in an effective heal accumulator arrangement. A sugar alcohol, selected from the group consisting of erythritol, threitol, xylitol, mannitol and dulcitol, has melting temperatures which lie significantly above the usual room temperature of approximately 20 degrees Celsius but is still below 200 degrees Celsius, which does not impose particularly high requirements on the handling and heat insulation in the vehicle. Xylitol has the chemical formula C5H12O5, erythritol and threitol each have the chemical formula C4H10O4, and mannitol and dulcitol each have the chemical formula C6H14O6, wherein the configuration for both erythritol and dulcitol, when compared to threitol and mannitol, is mirror-symmetric in terms of the middle of the chain. For example, the use of such sugar alcohols as latent heat accumulator agent in heal protection systems for measuring probes in geotechnical deep drilling is known from EP 0 236 382 B1. Such sugar alcohols have a high enthalpy of fusion, a good thermal stability, and are not or only slightly toxic for humans. With appropriate heat insulation, the heal accumulator arrangement can be positioned without problems in the vehicle interior near vehicle occupants. Therefore, this offers high flexibility for the selection of the location of the heat accumulator arrangement in the vehicle, wherein the high density of more than 1.4 kg/dm³ in the solid state of such sugar alcohols at the high enthalpy of fusion does not impose high volume requirements on the storage space for the heat accumulator arrangement with a latent heal accumulator agent according to the invention.

The dependent claims disclose advantageous embodiments, developments, and improvements of the corresponding subject matter of the invention.

According to an advantageous embodiment of the present heating system according to the invention, the latent heat accumulator agent comprises exclusively or almost exclusively erythritol. At approximately 120 degrees Celsius, the melting temperature of erythritol is not too high and suitable for the heat storage and for heating the air of a vehicle interior, and at a density of 1.46 kg/dm³, it has a high volume-related enthalpy of fusion of 488 kJ/dm³. Erythritol is not toxic for humans and inexpensive. In addition, sensible heat can still be utilized for the heating system after erythritol solidifies at more than 100 degrees Celsius down to less than 60 degrees Celsius. As a result, erythritol is particularly well suited as the sole or essential component of a latent heat accumulator agent for a heat accumulator arrangement of a heating system according to the invention.

According to a different advantageous embodiment of the present heating system according to the invention, the latent heat accumulator agent comprises a mixture of two or more sugar alcohols with compounds from the group consisting of erythritol, threitol, xylitol mannitol, and dulcitol. With such mixtures, particularly eutectic mixtures, the parameters front melting temperature, density, and mass-related and volume-related enthalpy of fusion can be changed toward a heat storage improved for the heating system according to the invention and the heating of the air for a vehicle interior. For example, in a eutectic mixture of mannitol and dulcitol with a molar ratio of 50 to 50, the density is 1.50 kg/dm³, the volume-related enthalpy of fusion is 423 kJ/dm³, and the melting temperature is approximately 153 degrees Celsius, which, compared to the individual sugar alcohols mannitol and dulcitol, is an advantageously reduced melting temperature.

Preferably, the at least one electric heating device is designed to heat the latent heat accumulator agent to a maximum temperature in the range from 121 degrees Celsius to 200 degrees Celsius. As a result, the electric heating device can melt the respective latent heat accumulator agent, such as erythritol, without problems, and latent heat can thus be stored well in the latent heat accumulator agent. In addition, the maximum temperature of the melted latent heat accumulator agent of the heat accumulator arrangement of the heating system according to the invention is thus not yet too high for heat-storage and heating of the air for a vehicle interior. As a result, the risk of reaching the respective boiling point of the corresponding sugar alcohol is prevented, and sensible heat can also be stored in the liquefied latent heat accumulator agent.

According to an advantageous development of the heating system according to the invention, the latent heat accumulator agent comprises as supercooling inhibitor an inorganic salt selected from phosphates, sulfates pyrophosphates, silver salts, inorganic acids, or silver halides. As a result, the solidification of the sugar alcohol(s) of the latent heat accumulator agent is improved by preventing supercooled liquid areas, and the storage capacity is increased with regard to latent heat.

Preferably, the switching arrangement of the heating system according to the invention is designed to couple the at least one electric machine in the generator mode during a braking process with the at least one electric heating device associated with the at least one heat accumulator arrangement, when the state of charge of the electric energy accumulator lies above or exceeds a predefined threshold value. As a result, a priority of the storage of the electric energy generated during the braking process is installed in the electric energy accumulator, and so the electric energy generated through recuperation is available primarily for the drive of the hybrid or electric vehicle and is only subsequently used for heat storage in the heat accumulator arrangement.

Preferably, the switching arrangement of the heating system according to the invention is designed to couple the electric machine with the at least one electric heating device associated with the at least one heat accumulator arrangement, when the charging current generated by the at least one electric machine in the generator mode during a braking process lies above or exceeds a predefined threshold value for the electric energy accumulator for the portion of the charging current lying above the threshold value. As a result, the surplus, portion of the generated electric energy, which the electric energy accumulator cannot store due to its limitation for the charging current, can be used for heat storage in the at least one heat accumulator arrangement.

Preferably, the heat accumulator arrangement of the heating system according to the invention has as heat insulation layer around at least a predominant part of the latent heat accumulator agent a easing with an air or vacuum gap. As a result, heat stored in the latent heat accumulator agent is thermally insulated particularly well from the surroundings and can thus be stored particularly long. With a position of the beat accumulator arrangement near vehicle occupants in the vehicle interior, the risk of thermally induced injuries of vehicle occupants is advantageously reduced or prevented due to the good thermal insulation.

According to an advantageous embodiment of the present heating system according to the invention, at least one heat accumulator arrangement is designed to be positionable directly behind the driver's seat. This provides the option of arranging the heat accumulator arrangement in otherwise unused space in the vehicle interior in the area for the vehicle occupants. Advantageously, the heat is stored in close vicinity to the area of the vehicle interior to be heated. Particularly for a convection heating circuit with convectors usually arranged in the lower area of the vehicle interior to be heated, for example, in a bus, the heat loss is small during the heat transport from a heat accumulator arrangement positioned such to the convectors due to its close vicinity. Corresponding advantages of the possible positioning also apply to the variation, in which at least one heat accumulator arrangement of the heating system is designed, to be positionable on, and particularly on top of, a wheelhouse. The area on top of or above a wheelhouse is frequently unused particularly in buses, and as a seat for passengers, it is subject to limitations regarding space requirements. Therefore, this position is particularly suitable for a heat accumulator arrangement. For the positioning behind the driver's seat, the heat accumulator arrangement preferably has a height of maximally 181 centimeters, a width of maximally 42 centimeters, and a depth of maximally 83 centimeters, or for the positioning on, and particularly on top of, a wheelhouse, it has a height of maximally 135 centimeters, a width of maximally 99 centimeters, and a depth of maximally 83 centimeters. As a result, the space requirement of the heat accumulator arrangement is not excessively great and, depending on the intended positioning, it is frequently still suitably dimensioned.

According to an advantageous embodiment of the present heating system according to the invention, the at least one heat accumulator arrangement is designed to directly convey heat stored in the heat accumulator arrangement by means of an air conveyor device to the air to be heated for the vehicle interior provided for vehicle occupants. As a result, the air to be heated is directly heated by the stored heat, which keeps the heat loss particularly low and does not require a separate heating circuit with its own medium to he heated, and so costs, weight, material, and expenditure can be reduced.

Taken into consideration are, for example, rib-like designed surfaces with a heat-conducting connection to the latent heat accumulator agent of the heat accumulator arrangement, around which, if necessary, the conveyed air can flow.

Preferably, at least one heat exchanger arrangement for conveying heat stored in the heat accumulator arrangement to a medium to be heated is associated with the at least one heat accumulator arrangement of the heating system. A heat exchanger arrangement is suitable particularly well for an effective heat exchange of heat stored in the latent heat accumulator agent to a medium to be heated. Depending on the medium to be heated, for example, air, the heat exchanger arrangement is designed correspondingly. According to a preferred embodiment, the medium to be heated is heating water of a heating circuit for heating the air of the vehicle interior provided for vehicle occupants. With a heating circuit, the areas of a vehicle to be heated can be reached particularly well and effectively. In addition to the heat accumulator arrangement, other heat sources, such as waste heat from an electric energy accumulator, and in case of a hybrid vehicle, from the motor of the non-electric drive type, can easily be used in a heating circuit for heating the heating water.

The second problem is solved by a heat accumulator arrangement for a heating system according to the invention, wherein the heat accumulator arrangement for heat storage has a latent heat accumulator agent, comprising substantially erythritol.

The third problem is solved by a hybrid or electric vehicle with a heating system according to the invention.

According to an advantageous embodiment of the hybrid or electric vehicle according to the invention, at least one heat accumulator arrangement of the heating system is arranged behind the driver's seat. As a result, frequently unused space in the vehicle interior in the area for the vehicle occupants is utilized with a heat accumulator arrangement. The heat is advantageously stored in close vicinity to the area of the vehicle interior to be heated. In a further advantageous embodiment of the hybrid or electric vehicle according to the invention, the at least one heat accumulator arrangement of the heating system is arranged on, and particularly on top of, a wheelhouse. The area on top of or above a wheelhouse is frequently unused, and as a seat for passengers, it is subject to limitations regarding space requirements. Therefore, this position is particularly suitable for a heat accumulator arrangement

Particularly advantageous is a hybrid- or electric bus as a hybrid or electric vehicle with a heating system according to the invention. A heating system according to the invention with a heat accumulator arrangement is particularly meaningful for a large area to the heated, e.g. the passenger area. The positions of the at least one heat accumulator arrangement on the wheelhouse, and/or behind the driver's seat are easily realized in a bus and especially effective particularly due to the close proximity to the convection heating circuit frequently located in the lower area.

The fourth problem is solved by a method for accumulating heat and releasing stored heat according to the features of claim 13. The fifth problem is solved in that the method for accumulating heat and releasing stored heat with a heating system according to the invention integrated in a hybrid or electric vehicle comprises the steps, firstly, a) of converting kinetic energy during braking of the hybrid or electric vehicle into electric energy by means of at Least one electric machine operated as a generator, secondly b) of converting the electric- energy into heat by means of the at least one heating device associated with the at least one heat accumulator arrangement of the heating system, and thirdly, characterizing the invention, the further steps c) and d) of storing c) heat converted according to step b) in the latent heat accumulator agent of the at least one heat accumulator arrangement of the heating system by storing it as sensible heat and/or as latent heat through phase transformation in the at least one sugar alcohol, comprising at least one compound selected from the group consisting of erythritol, threitoI, xylitol, mannitol, and dulcitol, and d) of releasing, if necessary, sensible and/or, latent heat stored in the latent accumulator agent in the at least one heat accumulator arrangement for heating air for or in the vehicle interior provided for vehicle occupants. The advantages described above for the heating system according to the invention apply accordingly to the method according to the invention.

In the method according to the invention, the latent heat accumulator agent preferably comprises exclusively or almost exclusively erythritol, and the conversion of electric energy into heat in method step b) stops automatically, when a predefined temperature of the latent heat accumulator agent in the range from 121 degrees Celsius to 200 degrees Celsius is exceeded. At approximately 120 degrees Celsius, the melting temperature of erythritol is not too high, and particularly with a high volume-related enthalpy of fusion, erythritol has good heat accumulator properties. Erythritol is not toxic for humans and inexpensive. Due to the automatic stoppage of the conversion of the electric energy into heat at the predefined temperature, the liquid erythritol is not heated too excessively for heating and the risk of reaching a boiling point is prevented. Therefore, the utilization of a latent accumulator agent consisting entirely or almost entirely of erythritol is particularly advantageous.

According to an advantageous development of the method according to the invention, the method steps b) and c) are executed, when the state of charge of an electric energy accumulator lies above or exceeds a predefined threshold value, and the electric energy generated through conversion in the first method step a) is otherwise fed to the electric energy accumulator. As a result, the electric energy accumulator is charged advantageously primarily for the chives and the electric energy converted into heat is only subsequently stored in the latent heat accumulator agent of the heat accumulator arrangement.

Preferably, the method steps b) and c) are executed only when the portion of the electric energy generated in step a) is associated with the portion lying above a predefined threshold value of the charging current generated by means of the at least one electric machine operated as a generator during the braking of the hybrid or electric vehicle. As a result, the other portion of the electric energy can be used predominantly for charging the electric energy accumulator without exceeding an upper threshold value of the charging current possible for the electric energy accumulator.

According to an advantageous development of the method according to the invention, the fourth method step, if required, of releasing sensible and/or latent heat stored in the latent accumulator agent in the at least one heat accumulator arrangement for heating air for or in the vehicle interior provided for vehicle occupants is executed only When the temperature of the air in the vehicle interior provided for vehicle occupants lies below or undercuts a predefined target temperature. This system improves the handling of heating air for or in the vehicle interior provided for vehicle occupants.

Finally, the features of the dependent claims regarding the heating system according to the invention, regarding the hybrid or electric vehicle according to the invention, and regarding the method according to the invention cap each essentially be, freely combined, and not only in the present sequence determined by the claims, within the dependent claims associated with the same main claim, provided they are independent from one another.

### BRIEF DESCRIPTION OF THE DRAWINGS

Embodiments of the invention shall be described using the drawings,

FIG. 1 shows a block diagram of an embodiment of the heating system according to the invention;

FIG. 2 shows a schematic depiction of an embodiment of a hybrid or electric vehicle as a bus with an installed heating system according to the invention; and

FIG. 3 shows a flowchart of an embodiment of a method for accumulating heat and releasing stored heat with a heating system according to the invention installed in a hybrid or electric vehicle.

### DETAILED DESCRIPTION OF THE INVENTION

All drawings are to be understood as schematic. For the purpose of increased clarity of the depiction, drawings to scale were foregone.

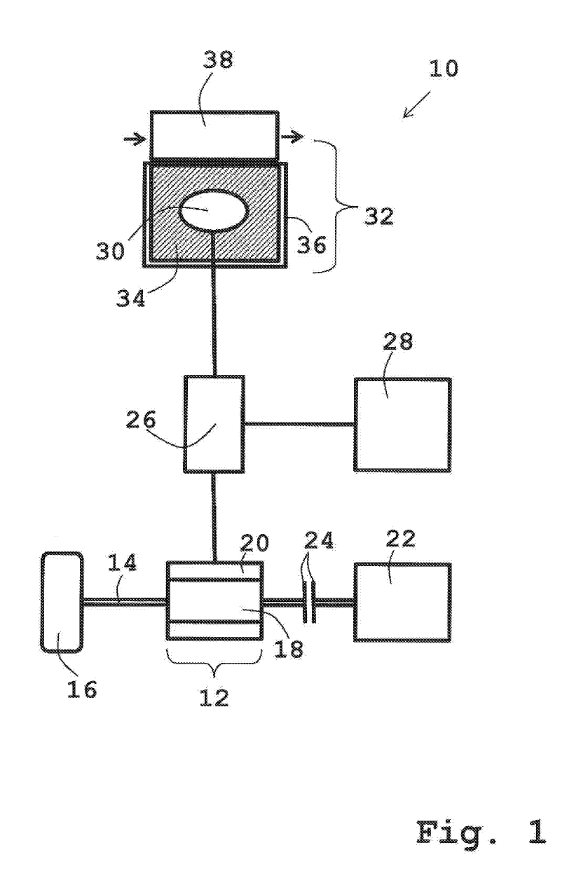

FIG. 1 shows a block diagram of an embodiment of the heating system 10 according to the invention in a hybrid or electric vehicle. By means of a shaft 14, the electric machine 12 is connected to at least one wheel 16 of the hybrid, or electric vehicle. During the braking process of the hybrid or electric vehicle, a torque is applied to the electric machine 12 via the shaft 14, wherein the electric machine 12, provided with a rotor 18 and a stator 20, converts in the generator mode the kinetic energy into electric energy. This recuperation into electric energy during braking according to the principle of the eddy current brake is a technology known for hybrid or electric vehicles. In this embodiment, the electric machine 12 can also be used as a drive motor of the hybrid or electric vehicle. However, electric machines 12, which are only used in the generator mode during the braking process, are also conceivable. Furthermore, embodiments are conceivable which contain a plurality of electric machines 12, for example, one for each wheel of the hybrid or electric vehicle. In the design as a hybrid vehicle, an internal-combustion engine 22 with a switchable clutch 24 can be coupled to the drive train. In a design as an electric vehicle, the internal-combustion engine 22 plus clutch 24 is omitted.

The electric energy generated by the electric machine 12 in the generator mode during the braking process is conducted to the switching arrangement 26 via an electric line. The switching arrangement 26 contains conventional switching elements, with which the, electric machine ::12 operating in the generator mode is optionally electrically connected to or coupled with either the electric energy accumulator 28 or the electric heating device 30. Circuits, in which the electric energy generated by the electric machine 12 is optionally simultaneously distributed partly to the electric energy accumulator 28 and partly top the electric heating device 30, are also conceivable. In this embodiment, the switching arrangement 26 contains a priority switching for coupling the electric machine 12 with the electric energy accumulator 28 prior to coupling the electric machine 12 with the electric heating device 30. Only when a state of charge of, for example, 85% of the maximum value of the electric energy accumulator 28 is reached or exceeded, the electric machine 12 operating in the generator mode during the braking process is coupled with the heating device 30. The electric energy accumulator 28 is, but not limited to, a lithium-ion battery usually provided for the electric drive.

The electric heating device 30 is associated with a heat accumulator arrangement 32. For accumulating heat, the heat accumulator arrangement 32 contains a latent heat accumulator agent 34. The electric heating device this case, the electric heating device 30 is located directly in the latent heat accumulator agent 34. For heating the latent heat accumulator agent 34, the electric heating device 30 comprises one or more FTC heating elements. The electric heating device 30 can also comprise, for example, one or more electric heating rods embedded in the latent heat accumulator agent 34. The latent heat accumulator agent 34 contains exclusively or almost exclusively the sugar alcohol erythritol The other sugar alcohols threitol, xylitol, mannitol, and dulcitol and mixtures of these sugar alcohols, such as the eutectic mixture of mannitol and dulcitol with the molar mixture ratio of 50 to 50, are also conceivable as latent heat accumulator agent 34. The melting points, densities, and enthalpies of fusion of the compounds threitol, xylitol, erythritol, mannitol, and dulcitol and the eutectic mixture of mannitol and dulcitol with the molar mixture ratio of 50 to 50 are listed in the following table.

TABLE

| | Melting point | Density | Enthalpy of fusion | |
|---|---|---|---|---|
| Substance | (° C.) | (kg/dm³) | (kJ/kg) | (kJ/dm³) |
| Threitol (T) | 71 | 1.46 | 223 | 326 |
| Xylitol (X) | 94 | 1.52 | 240 | 365 |
| Erythritol(E) | 120 | 1.46 | 334 | 488 |
| Mannitol (M) | 167 | 1.50 | 306 | 459 |
| Dulcitol (D) | 189 | 1.50 | 358 | 537 |
| M/D 50:50 | 153 | 1.50 | 282 | 423 |

In a particular embodiment of the latent heat accumulator agent 34, an inorganic salt selected from phosphates, sulfates, pyrophosphates, silver salts, inorganic acids, or silver halides can be added to the erythritol as supercooling inhibitor in, small quantities of, for example, 1% by weight proportion. Such supercooling inhibitors for the sugar alcohols erythritol, mannitol, and dulcitol are listed in EP 0 754 744 B1.

The electric heating device 30 is designed to be able to heat the latent heat accumulator agent 34, which almost exclusively comprises erythritol, above the melting point of approximately 120 degrees Celsius, and so it becomes liquid. When the predefined maximum temperature in the range from 121 degrees Celsius to 200 degrees Celsius for the latent heat accumulator agent 34 is reached or exceeded, for example, 130 degrees Celsius, the energy supply of electric energy to the electric heating device 30 is stopped. If the electric energy is available from the electric machine 12 during the braking process, it is once again fed to the electric, heating device 30 if the latent heat accumulator agent 34 cools down below a predefined temperature value, such as 124 degrees Celsius.

Except for a small portion of its outer surface, the latent heat accumulator agent 34 is encased by a heat insulation layer 36. The heat insulation layer 36 consists of, but is not limited to, an inner and outer layer made of a solid material with little heat conduction, tier example, a ceramic, and an air or vacuum gap in between. A heat exchanger arrangement 38 is connected to or associated with the heat accumulator arrangement 32 and is in direct heat-conducting connection with the small portion of the outer surface of the latent heat accumulator agent 34 not insulated in said manner. The heat exchanger arrangement 38 is designed, for example, in the manner of a plate heat exchanger. A medium to be heated, in this case heating water of a heating circuit, can flow through the heat exchanger arrangement 38. If necessary, latent heat and/or sensible heat stored in the latent heat accumulator agent 34 can be released in the heat exchanger arrangement 38 to the medium to be heated. If the temperature of the air of the vehicle interior for the vehicle occupants to be heated lies below a predefined value, the heat transfer of heat stored in the heat accumulator arrangement 32 to the medium to be heated is switched on and is used for heating the air of or for the vehicle interior. The medium to be heated, for example, can also be directly the air provided for the vehicle interior to be heated, which is blown beforehand by means of an air conveyor device, for example, a radial blower, through a heat exchanger arrangement 38 designed for such purpose and located on the heat accumulator arrangement 32. Such a heat exchanger arrangement 38 has, for example, ribs which are made of a material with good heat conduction, and which are in thermal communication with the latent heat accumulator agent 34.

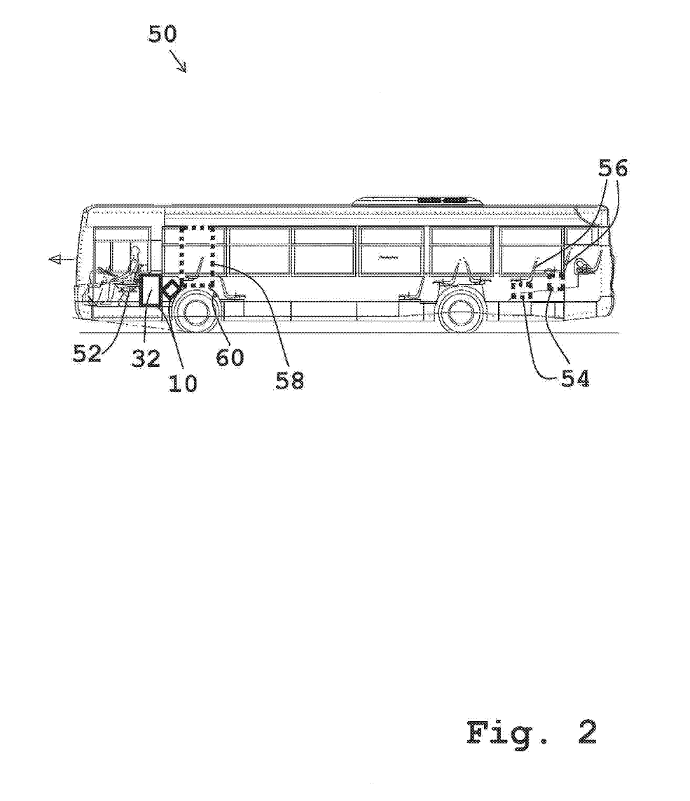

FIG. 2 shows a schematic depiction of an embodiment of a hybrid, or electric vehicle 50 as a hybrid or electric bus with an installed heating system 10 according to the invention. A driver is also shown schematically on the driver's seat 52. The heating system 10 corresponds to the one described for FIG. 1. Of all the individual components of the heating system 10, such as electric machine, electric heating device, and switching arrangement, only the accumulator arrangement 32 is shown in FIG. 2 individually from the outside. The heat accumulator arrangement 32 is positioned directly behind the driver's seat 52. In this case, it has a width of 40 centimeters, a height of 80 centimeters, and, a depth of 80 centimeters, but it is not limited to these dimensions. The installation space, in which the heat accumulator arrangement 32 is installed, is located in the otherwise unused space behind the driver's seat 52. Due to the good heat accumulator properties of the latent heat accumulator agent according to the invention, comprising at least one sugar alcohol, which comprises at least one compound selected from the group consisting of erythritol, threitol, xylitol mannitol, and dulcitol, the volume of the installation space behind the, driver's seat 52 is adequate for a sufficient heat accumulation. Particularly suitable alternative positions for at least one or further heat accumulator arrangement(s) 32 of the heating system 10 according to the invention are, for example, the installation space 54 shown dashed under one or more passenger seats 56 and/or the installation space 58 on or above a wheelhouse 60 of the hybrid or electric vehicle 50 designed as a hybrid or electric bus. Usually, these installations spaces are also not obstructed and offer sufficient space for heat accumulator arrangements 32 according to the invention with a sufficient heat accumulator capacity. The hybrid or electric vehicle 50 designed as a hybrid or electric bus can be purely an electric vehicle or a hybrid vehicle. Both variations are possible for FIG. 2.

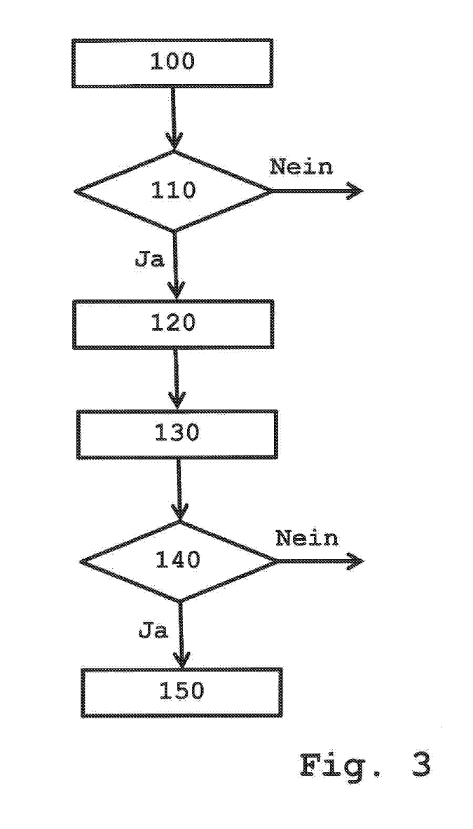

FIG. 3 shows a flowchart of an embodiment of a method for accumulating heat and releasing stored heat with a heating system according to the invention installed in a hybrid or electric vehicle. In the first step 100, the kinetic energy during the braking of the hybrid or electric vehicle is converted into electric energy by means of an electric machine operated as a generator of the heating system according to the invention in step 120, this electric energy is subsequently completely or partly converted into heat by means of an electric heating device associated with the heat accumulator arrangement of the heating system, when, “yes,” beforehand during the automatic test 110, the state of charge of the electric energy accumulator of the hybrid or electric vehicle lies above or exceeds a predefined threshold value of, for example 80% of the maximum value, or only the portion of the electric energy generated in the first step 100 which is associated with the portion lying above a further predefined threshold value of the charging current generated during the braking of the hybrid or electric vehicle by means of the at least one electric machine operated as a generator. This predefined further threshold value orients itself by the maximum value of the charging current permissible first the electric energy accumulator. This maximum value depends particularly on the type, size, and the state of charge of the respective electric energy accumulator. Said threshold value can accordingly also be, adjusted temperature-dependently to the temperature of the electric energy accumulator because the maximum value of the permissible charging current for electric energy accumulators is temperature-dependent.

Otherwise, in case of “no,” the electric energy generated in step 100 through conversion, or the portion of said electric energy not to be converted further into heat, is fed to the electric energy accumulator. The electric heating device is, for example, a PTC heating element.

The electric energy converted into heat in, step 120 is stored in step 130 in the latent heat accumulator agent of the beat accumulator arrangement of the heating system as sensible heat and/or as latent heat through phase transition. The latent heat accumulator agent comprises predominantly at least one sugar alcohol which comprises at least one compound selected from the group consisting of erythritol, threitol, mannitol, and dulcitol. In this embodiment, the latent heat accumulator agent consists exclusively or almost exclusively of erythritol. In an optional variation of the method, it stops automatically prior to step 120, when a predefined temperature of the latent heat accumulator agent in the range from 121 degrees Celsius to 200 degrees Celsius, for example, 140 degrees Celsius, exceeded. If the latent heat accumulator agent subsequently cools down again, for example, to below 130 degrees Celsius, the method starts up again.

After step 130, test 140 verifies, whether “yes,” there is demand for the release of heat from the heat accumulator arrangement stored in the latent heat accumulator agent for heating air fir or in the vehicle interior provided for vehicle occupants, and the air in said vehicle interior lies below a predefined target temperature, for example, of 22 degrees Celsius, or whether “no” there is no demand or the target temperature has not yet been undercut. In case of a positive test 140, i.e. “yes,” the sensible and/or latent heat stored in the heat accumulator arrangement in the latent heat accumulator agent is released in the final step 150 for heating air for or in the vehicle interior provided for vehicle occupants. This is achieved, for example, by means of a subsequently activated heat exchanger arrangement.

The heating system according to the invention, with which the method, according to the invention can be executed, is usable for hybrid or electric vehicles, particularly advantageously in buses. The heat accumulation in the heat accumulator arrangement with the latent heat accumulator agent according to the invention, which advantageously is inexpensive, readily available and only slightly or not at all toxic for humans, is particularly effective and suitable. The operating temperatures of the heat accumulator arrangement are sufficiently low for a not particularly elaborately heat-insulated positioning in the vehicle interior provided for vehicle occupants,

1. A heating system (10) for a hybrid or electric vehicle (50) comprising at least one electric machine (12) operable in the generator mode, at least one heat accumulator arrangement (32), at least one electric heating device (30) associated with the heat accumulator at (32), and a switching arrangement (26), wherein the switching arrangement (26) is designed to optionally couple the at least one electric machine (12) with the at least one electric heating device (30) and/or an electric energy accumulator (28), when the at least one electric, machine (12) operates in the generator mode during a braking process, characterized in that:
the heat accumulator arrangement (32) has a latent heat accumulator agent (34) for heat storage, comprising at least one sugar alcohol which comprises at least one compound selected from the group consisting of erythritol, threitol, xylitol, mannitol, and dulcitol.

2. The heating system (10) according to claim 1, characterized in that the latent heat accumulator agent (34) comprises substantially erythritol,

3. The heating system (10) according to claim 1, characterized in that the latent heat accumulator agent (34) comprises a mixture of two or more sugar alcohols with compounds from the group consisting of erythritol, threitol, xylitol, mannitol, and dulcitol.

4. The heating system (10) according to claim 1, characterized in that the at least one electric heating device (30) is designed to heat the latent heat accumulator agent (34) to a maximum temperature in the range from 121 degrees Celsius to 200 degrees Celsius.

5. The heating system (10) according to one of the claim 1, characterized in that the latent heat accumulator agent (34) comprises as a supercooling inhibitor an inorganic salt selected from phosphates, sulfates, pyrophosphates, silver salts, inorganic acids, or silver halides.

6. The heating system (10) according to claim 1, characterized in, that at least one heat accumulator arrangement (32) is designed to be positionable directly behind the driver's seat (52) or on, and particularly on top of, a wheelhouse (60).

7. The heating system (10) according to claim 6, characterized in, that at least one heat accumulator arrangement (32) for the positioning behind the driver's seat (52) has a height of maximally 181 centimeters, a width of maximally 42 centimeters, and a depth of maximally 83 centimeters, or for the positioning on, and particularly on top of, a wheelhouse (60), it has a height of maximally 135 centimeters, a width of maximally 99 centimeters, and a depth of maximally 83 centimeters.

8. The, heating system (10) according to claim 1, characterized in that the at least one heat accumulator arrangement (32) is designed to directly convey heat stored in the heat accumulator arrangement by means of an air conveyor device to the air to be heated for the vehicle interior provided for vehicle occupants.

9. The heating system (10) according to claim 1, characterized in that at least one heat exchanger arrangement (38) for, conveying heat stored in the heat accumulator arrangement (32) to a medium to be heated, particularly heating water of a heating circuit for heating the air of the vehicle interior provided for vehicle occupants, is associated with the at least one heat accumulator arrangement (32).

10. The heat accumulator arrangement (32) for a heating system (10) according to claim 2, characterized in that the heat accumulator arrangement (32) for accumulating heat has a latent heat accumulator agent (34), comprising substantially erythritol.

11. A hybrid or electric vehicle (50) particularly a hybrid or electric bus, with a heating system (10), the heating system (10) comprising at least one electric machine (12) operable in the generator mode, at least one heat accumulator arrangement (32), at least one electric heating, device (30) associated with the heat accumulator arrangement (32), and a switching arrangement (26) wherein the switching arrangement (26) is designed to optionally couple the at least one electric machine (12) with the at least one electric heating device (30) and/or an electric energy accumulator (28), when the at least one electric machine (12) operates in the generator mode during a braking process, characterized in that:
the heat accumulator arrangement (32) has a latent heat accumulator agent (34) for heat storage, comprising at least one sugar alcohol which comprises at least one compound selected from the group consisting of erythritol, threitol, xylitol, mannitol, and dulcitol.

12. The hybrid or electric vehicle (50) according to claim 11, characterized in that at least one heat accumulator arrangement (32) of the heating system (10) is, arranged behind the driver's seat (52) or on, and particularly on top of, a wheelhouse (60).

13. A method for accumulating heat and releasing stored heat with a heating system (10) integrated in a hybrid or electric vehicle (50), comprising the steps:
a) of converting (100) kinetic energy during braking of the hybrid or electric vehicle (50) into electric energy by means of at least one electric,machine (12) operated as a generator;
b) of converting (120) the electric energy into heat by means of an at least one heating device (30) associated with an at least one heat, accumulator arrangement (32) of the heating system (10), characterized by the further steps
c) of storing (130) heat converted according to step b) in an latent heat accumulator agent (34) of an at least one heat accumulator arrangement (3) of the heating system (10) by storing it as sensible heat and/or as latent heat through phase transformation in the at least one sugar, alcohol, comprising at least one compound selected from the group consisting of erythritol, threitol, mannitol, and dulcitol; and
d) of releasing (150), if necessary, sensible and/or latent heat stored in the intent accumulator agent (34) in the at least one heat accumulator arrangement (32) for heating air for or in the vehicle interior provided for vehicle occupants.

14. The method according to claim 13, characterized in that the latent heat accumulator agent (34) comprises substantially erythritol, and the conversion (120) of electric energy into heat in step b) stops automatically, when a predefined temperature of the latent heat accumulator agent in the range from 121 degrees Celsius to 200 degrees Celsius is exceeded.

15. The method according to claim 13, characterized in that step d) (150) is executed only when the temperature of the air in the vehicle interior provided for vehicle occupants lies below or undercuts a predefined target temperature.
